(19) United States
(12) Patent Application Publication
(10) Pub. No.: US 2012/0073906 A1
(43) Pub. Date: Mar. 29, 2012

(54) Device for filtering lubricants in a transmission

(76) Inventors: Michaela Brasseur, Aachen (DE); Matthias Wohlleb, Wurselen (DE)

(21) Appl. No.: 13/246,055

(22) Filed: Sep. 27, 2011

(30) Foreign Application Priority Data
Sep. 28, 2010 (DE) 10 2010 041 559.6

(51) Int. Cl. F01M 11/00; B03C 1/02; F03D 11/00; F01M 1/10

(52) U.S. Cl. 184/6.25

(57) ABSTRACT

A device for filtering lubricants in a transmission includes a fine filter element which is arranged in a transmission casing and in a lubricant flow in such a way that contaminants of a lubricant are filtered out as a function of a size of the contaminants. The device further includes a magnetic filter element which is arranged spatially separated from the fine filter element. The magnetic filter element is arranged in the transmission casing and in the lubricant flow in such a way that magnetizable contaminants in the lubricant are filtered out with the aid of a magnetic field of the magnetic filter element.

### CROSS REFERENCE TO RELATED APPLICATIONS

This application claims priority of German Patent Application No. 10 2010 041 559.6 DE filed Sep. 28, 2010, which is incorporated by reference herein in its entirety.

### FIELD OF INVENTION

The invention relates to a device for filtering lubricants in a transmission.

### BACKGROUND OF INVENTION

Wear and tear on machine components lead to abrasion. Solid wear debris particles resulting therefrom cause further mechanical wear and lead to further abrasion. Since wear debris particles are the primary cause of premature failure of machine parts, it is necessary to remove them from the lubricant in order to be able to achieve the longest possible machine running time.

Filter systems are generally used for separating particles from lubricant. It is known to use filter elements having fine cellulose fibers, for example with a diameter of 3 μm. The filter systems are often arranged outside of the main flow.

However, these known fine filter systems have the drawback that larger particles, e.g. larger metal particles or nonmagnetic particle agglomerates, quickly clog the filter. For this reason the filter needs to be exchanged at appropriately frequent intervals in order to be able to guarantee optimal filtering.

The wear debris present in the lubricant consists principally of metal particles of widely varying size. Thanks to its material properties said metallic wear debris can be filtered out with the aid of a magnetic separator.

Fine filter systems with integrated magnetic separators for separating metal particles from lubricant are known for this purpose. Such filter systems are also used in wind turbine generators for filtering the transmission lubricant.

A disadvantageous aspect of this approach is that the entire filter element has to be replaced when the fine filter becomes saturated. Maintaining said filter systems is time-consuming, labor-intensive and costly. This is true in particular in the case of offshore wind turbine generators with filter systems that are difficult to access.

Furthermore, in addition to the pure material and human resource costs involved in changing a filter, further costs are incurred due to the downtime of the wind turbine generator.

### SUMMARY OF INVENTION

An object of the claimed invention is to propose an improved device for filtering transmission lubricant which allows long maintenance intervals as well as simple and quick replacement of filter elements.

This object is achieved by a device for filtering lubricants as claimed in the independent claim Advantageous developments of the claimed invention are defined in the dependent claims.

The invention relates to a device for filtering lubricants in a transmission in which moving transmission parts are arranged in a transmission casing. The transmission parts are at least partially wetted by the lubricant.

The device comprises a per se known fine filter element which is arranged in the transmission casing and in the lubricant flow in such a way that contaminants in the lubricant are filtered out as a function of their size.

In addition the device includes a magnetic filter element which is arranged spatially separated from the fine filter element.

The magnetic filter element is arranged in the transmission casing and in the lubricant flow in such a way that magnetizable contaminants in the lubricant are filtered out with the aid of a magnetic field of the magnetic filter element.

The magnetic filter element is advantageously embodied in such a way that it can be used as a primary filter or pre-filter. This enables the above-described shortcomings of known filter devices to be overcome.

The majority of the metal particles contained in the lubricant are intercepted already at the magnetic filter element, to which they adhere, and do not reach the fine filter with its filter elements based on cellulose fibers.

Moreover, nonmagnetic wear debris remains attached to the surfaces of the metal particles, resulting in the formation of agglomerates consisting of metallic and nonmetallic particles which are likewise filtered out of the lubricant by means of the magnetic filter element.

The device according to the invention has the further advantage that it can be replaced independently of a fine or main filter connected downstream in the lubricant flow direction.

An embodiment variant of the invention contains two openings in the transmission casing. This has the advantage that a saturated magnetic filter element can be ejected from the transmission and a replacement filter element introduced into the transmission simultaneously or in immediate succession. This filter replacement is accomplished in a comparatively short downtime.

### BRIEF DESCRIPTION OF THE DRAWINGS

Embodiment variants of the present invention are described in an exemplary manner with reference to the appended drawings, in which:

FIG. 1: shows a first cross-sectional view of an embodiment variant of the device according to the invention as a cross-section along the transverse axis of the magnetic filter element, and

FIG. 2: shows a second cross-sectional view of an embodiment variant of the device according to the invention as a cross-section along the longitudinal axis of the magnetic filter element.

### DETAILED DESCRIPTION OF INVENTION

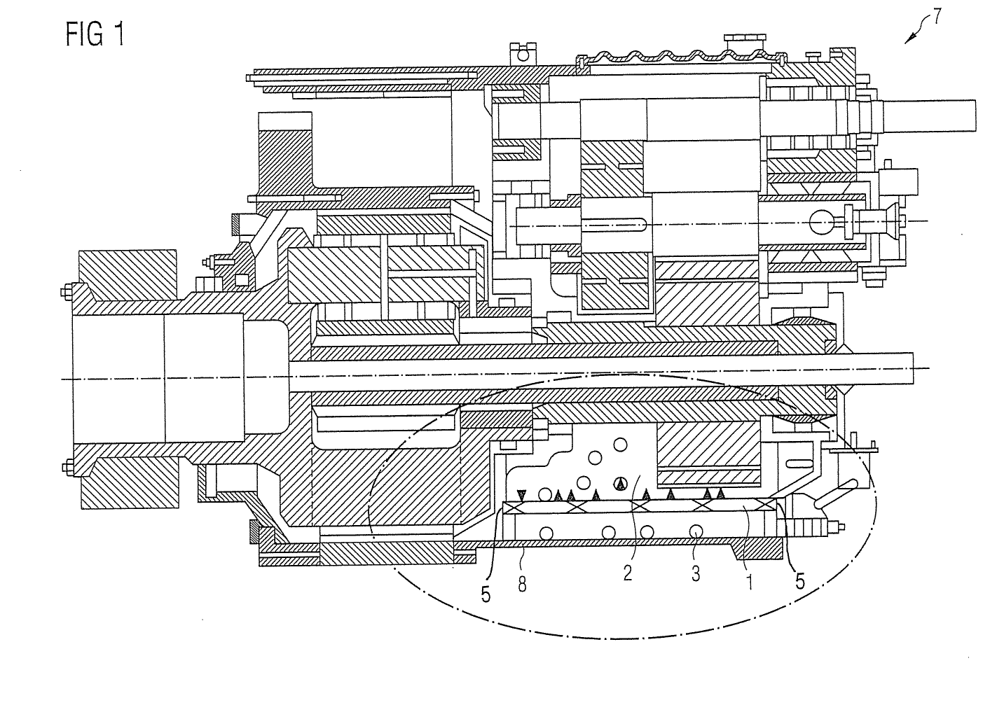

As shown in FIG. 1, the device 7 comprises a magnetic separator 1 which is embodied as a grid plate. Disregarding its low height, it therefore has substantially the shape of a two-dimensional grid surface. The mesh size of the grid network of the grid surface ranges between 10 μm and 5 mm, for example.

In one embodiment variant of the invention, the grid surface is in the shape of a rectangle and is delimited by two long sides and two short sides 5. Other shapes are possible, the magnetic separator 1, irrespective of the precise surface shape, having a longitudinal axis and a comparatively shorter transverse axis thereto.

As shown in FIG. 1, the magnetic separator 1 is arranged in the oil pan 2 of the transmission casing 8, for example over the oil bath of the dry sump lump lubrication, in order to ensure that all of the transmission oil 3 flows through the magnetic separator 1.

In a further embodiment variant of the invention, the transmission 7 is part of a wind turbine.

The magnetic separator 1 is arranged below the moving transmission parts in the transmission casing 8. The arrangement is implemented in such a way that the longitudinal axis of the grid surface or grid plate is aligned transversely with respect to the longitudinal axis of the shaft, e.g. the spur gear shaft.

The distance between the two short sides 5 is chosen in this case such that the magnetic separator 1 extends up to the transmission casing 8.

Alternatively thereto, given other proportions of the transmission 7, the magnetic separator 1 according to the invention can also be oriented in such a way that the longitudinal axis of the grid surface is aligned parallel to the shaft, e.g. spur gear shaft.

In this case the distance between the two long sides is chosen such that the magnetic separator extends up to the transmission casing 8.

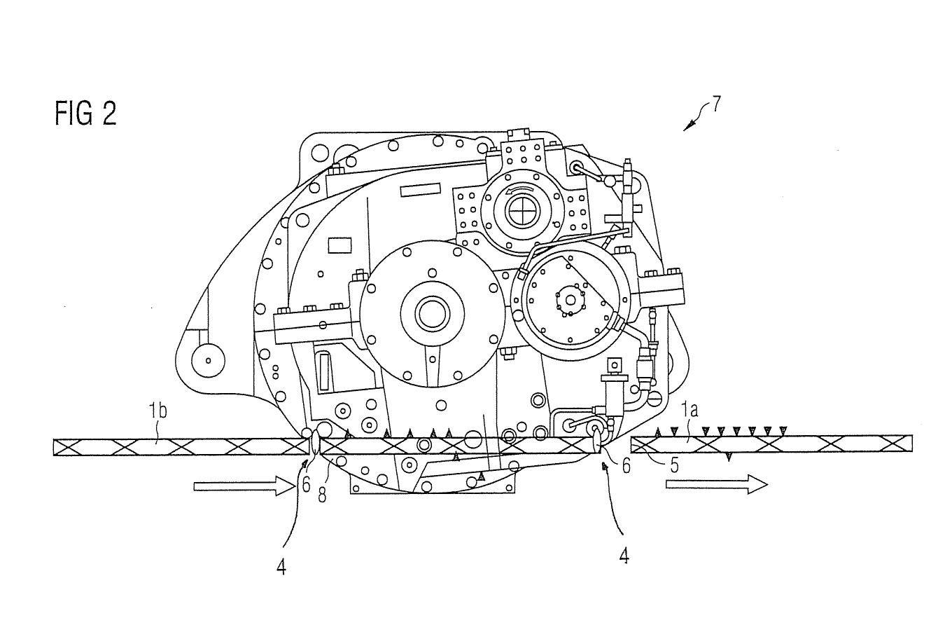

According to FIG. 2, the transmission casing 8 itself has openings 4. Preferably, two openings 4 are provided. More than two openings 4 in the transmission casing 8 would also be conceivable in order to enable the magnetic filter element 1 to be accessible from different sides of the transmission.

In the embodiment variant shown in FIG. 2, the openings 4 are dimensioned in accordance with the length of the short sides 5 and the height of the magnetic separator 1. They are embodied in such a way that the magnetic separator 1 can be inserted into the transmission casing 8 and/or extracted and/or ejected from the transmission casing 8 through the openings 4.

The openings 4 are arranged in the areas of the transmission casing 8 that are disposed opposite the short sides 5 of the magnetic separator 1.

In a further embodiment variant of the invention (not shown), the transmission casing has only a single opening. The magnetic separator is both inserted into the transmission casing and withdrawn from the transmission casing through said opening.

In order to avoid an unintended loss of oil, the opening 4 is provided with a seal 6. In one embodiment variant of the invention, the seal 6 is arranged securely but removably on the casing, inserted for example.

In another embodiment variant of the invention, the seal 6 is fixed, e.g. glued, to the magnetic separator 1 and is removed from the opening by moving the magnetic separator 1.

During servicing, it is sufficient to remove a seal 6 or a plurality of the seals 6 and to extract or push out the saturated magnetic separator 1 through an opening 4. The magnetic separator 1 can then be cleaned directly on site by a service engineer and reused.

As shown in FIG. 2, a saturated magnetic separator 1a can also be replaced by a replacement separator 1b.

In the case of a wind turbine transmission, the downtime of the wind turbine is further reduced in this way. With this alternative, the saturated magnetic separator 1a is cleaned at a later time and used as a replacement filter for another wind turbine.

Furthermore, it is possible to replace a saturated magnetic separator 1a with a replacement separator 1b. For that purpose the saturated magnetic separator 1a can be pushed out of the transmission at an opening 4 and a replacement separator 1b inserted into the transmission at another opening 4 either simultaneously or with a time delay.

In a further embodiment variant of the invention, a control unit and at least one motor are connected to the magnetic separators (1a, 1b) so that the replacement of the magnetic separator 1a by the magnetic separator 1b can be accomplished in an automated manner during ongoing operation of the machine, e.g. a wind turbine.

Cleaning or exchanging the magnetic separator 1a, 1b is possible independently of the replacement of the main filter. When the filter system according to the invention is used, the maintenance costs of the wind turbine are therefore reduced. Furthermore the reusable magnetic separator 1, 1a, 1b helps in reducing environmental pollution.

1.-15. (canceled)

16. A device for filtering lubricants in a transmission, comprising:
a fine filter element which is arranged in a transmission casing such that contaminants in a lubricant are filtered out as a function of sizes of the contaminants; and
a magnetic filter element which is arranged spatially separated from the fine filter element in the transmission casing such that magnetizable contaminants in the lubricant are filtered out with the aid of a magnetic field of the magnetic filter element,
wherein moving transmission parts of a transmission are arranged in the transmission casing and are at least partially wetted by the lubricant.

17. The device as claimed in claim 16, wherein the magnetic filter element comprises a magnetized grid.

18. The device as claimed in claim 17, wherein the grid is embodied as a flat component.

19. The device as claimed in claim 16, wherein the magnetic filter element is arranged in a lubricant sump of the transmission.

20. The device as claimed in claim 19, wherein the magnetic filter element is movably mounted in the lubricant sump of the transmission.

21. The device as claimed in claim 16, wherein the transmission casing comprises an opening through which the magnetic filter element is introduced into the transmission casing and/or extracted from the transmission casing.

22. The device as claimed in claim 21, wherein the opening is closed by a seal in order to prevent the lubricant from leaking out of the transmission casing.

23. The device as claimed in claim 16, wherein the transmission casing comprises two openings.

24. The device as claimed in claim 16, wherein the magnetic filter element is arranged in a lubricant flow upstream of the fine filter element and can be replaced independently of the fine filter element.

25. The device as claimed in claim 16, wherein the magnetic filter element can be replaced while a transmission is in operation.

26. The device as claimed in claim 16, wherein the magnetic filter element is embodied such that nonmetallic contaminants adhering to the metallic contaminants in the lubricant are filtered out together with the metallic contaminants.

27. The device as claimed in claim 16, wherein the transmission is a wind turbine transmission.

28. The device as claimed in claim 16, wherein the magnetic filter element is arranged below the moving transmission parts.

29. The device as claimed in claim 16,
wherein the magnetic filter element has a longitudinal axis,
wherein the moving transmission parts include a shaft with a longitudinal axis, and
wherein the longitudinal axis of the magnetic filter element is arranged transversely with respect to the longitudinal axis of the shaft.

30. A wind turbine, comprising:
a fine filter element which is arranged in a transmission casing of a transmission such that contaminants in a lubricant are filtered out as a function of sizes of the contaminants; and
a magnetic filter element which is arranged spatially separated from the fine filter element in the transmission casing such that magnetizable contaminants in the lubricant are filtered out with the aid of a magnetic field of the magnetic filter element,
wherein moving transmission parts of a transmission are arranged in the transmission casing and are at least partially wetted by the lubricant.

31. The wind turbine as claimed in claim 30, wherein the magnetic filter element comprises a magnetized grid.

32. The wind turbine as claimed in claim 30, wherein the magnetic filter element can be replaced while a transmission is in operation.

33. The wind turbine as claimed in claim 30, wherein the magnetic filter element is embodied such that nonmetallic contaminants adhering to the metallic contaminants in the lubricant are filtered out together with the metallic contaminants.

34. The wind turbine as claimed in claim 30, wherein the magnetic filter element is arranged below the moving transmission parts.

35. The wind turbine as claimed in claim 30,
wherein the magnetic filter element has a longitudinal axis,
wherein the moving transmission parts include a shaft with a longitudinal axis, and
wherein the longitudinal axis of the magnetic filter element is arranged transversely with respect to the longitudinal axis of the shaft.
